(19) United States
(12) Patent Application Publication
(10) Pub. No.: US 2013/0117249 A1
(43) Pub. Date: May 9, 2013

(54) LOCALE CENTRIC SEARCH OPTIMIZATION IN RESPONSE TO USER OPT-IN

(71) Applicants: Martello Michealangelo Jones, Ottawa (CA); Karthigesu Niranjan, Ottawa (CA)

(72) Inventors: Martello Michealangelo Jones, Ottawa (CA); Karthigesu Niranjan, Ottawa (CA)

(73) Assignee: RESEARCH IN MOTION LIMITED, Waterloo, ON (CA)

(21) Appl. No.: 13/634,959

(22) PCT Filed: Sep. 12, 2011
(86) PCT No.: PCT/CA11/50551

§ 371 Date: Jan. 7, 2013

(51) Int. Cl. G06F 17/30

(52) U.S. Cl. CPC G06F 17/3097; G06F 17/30864
USPC 707/706; 707/767

(57) ABSTRACT

The present disclosure provides for locale-centric search optimization upon user opt-in. In response to receiving a search query generated by a user of an electronic communication device who has opted to receive search suggestions that are relevant to a locale, a search engine server provides to the user at least one keyword suggestion that is relevant to the locale and can then perform a search on an updated search query generated by the user of the electronic communication device. The updated search query may include the initial search query, or the at least one keyword suggestion provided to the user that is relevant to the locale, or some combination. The search engine server returns the results of the search on the updated search query to the user via the electronic communication device.

### TECHNICAL FIELD

The present disclosure relates generally to the field of search optimization, and more particularly to a locale-centric search optimization with user opt-in in a communications network.

### BACKGROUND

Users of electronic communication devices, including mobile or wireless devices such as smart phones, mobile phones, and personal digital assistants or PDAs, have access to a number of convenient and useful applications installed on their electronic communication devices. Email, calendar, Web browser and Internet search applications are some examples.

With use of a Web browser or search application, an electronic communication device operating in a communication environment, such as a wireless network, may interface with a server of another communication network (e.g. the Internet) to access information. A user of the communication device may enter in a domain name of a URL in the Web browser application in a request to access a web page of the server. Additionally, if the server is or has a search engine, the user may also submit search (e.g. text) parameters in a search application installed on the electronic communication device via a Web page in a request to initiate a search for information via the search engine based on the entered search parameters. Depending on the (world-wide) location of the mobile device or the location of the user, however, an unexpected web site, less than useful search results, or irrelevant information may be received in response to the search request.

### BRIEF DESCRIPTION OF THE DRAWINGS

Example embodiments of the present disclosure will be described below with reference to the included drawings such that like reference numerals refer to like elements and in which:

FIG. 1 is a block diagram of a communications system that includes a search engine server, a communications network, and various communication devices, in accordance with various example embodiments of the present disclosure;

FIG. 2 is a block diagram of a wireless communication system 200, in accordance with various example embodiments of the present disclosure;

FIG. 3 is a detailed block diagram of an example mobile communication device, in accordance with various example embodiments of the present disclosure;

FIG. 4 illustrates an example user interface of a communication device, in accordance with various example embodiments of the present disclosure;

FIG. 5 illustrates applications that may be stored in a memory of a communication device, in accordance with various example embodiments of the present disclosure;

FIGS. 6 and 7 illustrate flows illustrative of various methods, in accordance with various example embodiments of the present disclosure.

### DETAILED DESCRIPTION

In accordance with the various example embodiments presented herein, a user of a communication device, which may be wireless, mobile, or both, but is possessed of at least data and possibly also voice communication capabilities, is able to better and more efficiently search using a search application, which might be accessed by the user of the communication device to perform a search over the Internet or World Wide Web using a browser. The user, when exercising an option to “opt-in,” is able to narrow or at least more precisely construct a search with a locale of interest in mind and thus more likely to receive better search results for the locale of interest.

Search engine servers of the kind used by search engines store terms associated with different locales, such as different countries, regions, map locations and geographical areas, for example. So when a user conducts a search, exercising an option to narrow the search results to a particular locale, local terms are provided as keyword suggestions to the user.

Consider the example of a user searching for “winter cap” who has opted-in to narrow the search results to Canada. A search of local terms specific to Canada for “winter cap” in a search database by the search engine server will yield a keyword suggestion of “tuque” that can then be provided to the user. Additionally, when a user types a query, the top popular terms in that region or locale matching the query are suggested to the user. Consider a user in the Caribbean typing “Appl”. This user will be given the suggestion “Appleton.” But the same “Appl” query in Cupertino, Calif. might be given “Apple” as a suggestion.

Therefore, in accordance with an example embodiment of the present disclosure, there is provided a method of search optimization, including: in response to receiving a search query and an option to receive search suggestions that are relevant to a locale, a search engine server providing at least one keyword suggestion that is relevant to the locale; the search engine server performing a search on an updated search query comprising one or more of the search query and the at least one keyword suggestion that is relevant to the locale; and the search engine server returning the results of the search on the updated search query.

In accordance with another example embodiment of the present disclosure, there is provided a method of search optimization, including: in response to receiving a search query, determining whether an option to receive search suggestions that are relevant to a locale is also received; if it is determined that the option to receive search suggestions that are relevant to the locale is also received, providing at least one keyword suggestion that is relevant to the locale; performing a search on an updated search query comprising one or more of the search query and the at least one keyword suggestion that is relevant to the locale; and returning the results of the search on the updated search query.

In accordance with a further example embodiment of the present disclosure, there is provided a search engine server, coupled to a communications network, that facilitates locale centric search optimization, including: a processor; and a search database coupled to and in cooperative arrangement with the processor, the search database comprising one or more locale-specific databases, and the processor and the search database configured to: in response to receiving a search query and an option to receive search suggestions that are relevant to a locale, provide at least one keyword suggestion that is relevant to the locale.

For simplicity and clarity of illustration, reference numerals may be repeated among the figures to indicate corresponding or analogous elements. Numerous details are set forth to provide an understanding of the example embodiments described herein. The example embodiments may be practiced without these details. In other instances, well-known methods, procedures, and components have not been described in detail to avoid obscuring the example embodiments described. The description is not to be considered as limited to the scope of the example embodiments described herein.

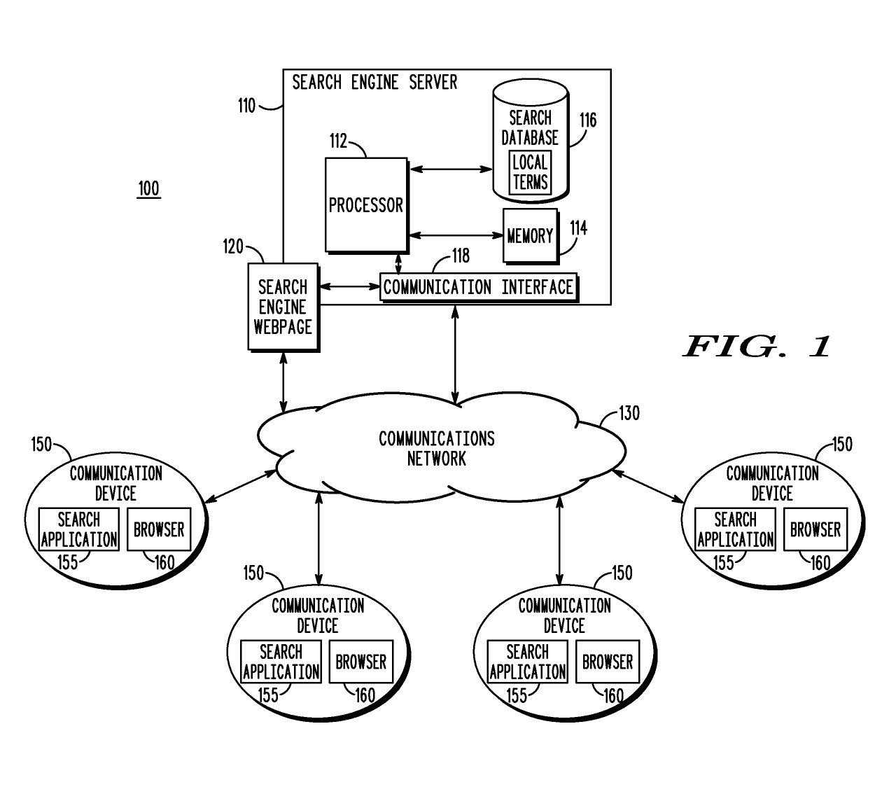

Referring now to FIG. 1, a block diagram of a distributed communications system that includes a search engine server, a communications network, and various communication devices, in accordance with various example embodiments of the present disclosure, is illustrated. The distributed system 100 includes search engine server 110 and a number of communication devices 150, all of which are coupled to communications network 130. Although network 20 may be the World Wide Web or Internet, and in fact search engine server 110 may reside on the World Wide Web, it is understood that the search engine servers and communication devices 150 may be coupled together by various types of networks, such as local area networks (LANs), other wide area networks (WANs) and regional networks accessed over telephone lines, such as commercial information services.

Search engine server 110 may include a processor 112, a memory 114, search database 116, and communication interface 118. The search engine server 110 is able to communicate with the communications network via communication interface 118, as shown. Search engine server permits network users, upon navigating to the search engine web server URL or sites on other web servers capable of submitting queries to search engine server 110, to enter queries to which the search engine server generates a search result list. The search engine server 110 can generate a list of hypertext links to documents that contain information relevant to search terms entered by the user at the user interface of the communication device 150. This list may be transmitted in the form of a web page, to the user at his communication device 150 via the communications network 130, where it can be displayed on the browser 160 running on the communication device.

Search engine server 110 includes a search database 116 of search listing records used to generate search results in response to user queries. The users may access, via their browsers 160, a search engine web page 120 residing on search engine server 110. The search engine web page 120 has a query box in which the user can enter, by typing, a search term of one or more keywords. Or, the user can query the search engine server 110 through a query box hyperlinked to the search engine server 24 and located on a web page stored at a remote web server. When the user has finished entering the search term, he may transmit the search query to search engine server 110 by clicking on a provided hyperlink. The hypertext links can access web pages anywhere on the Internet.

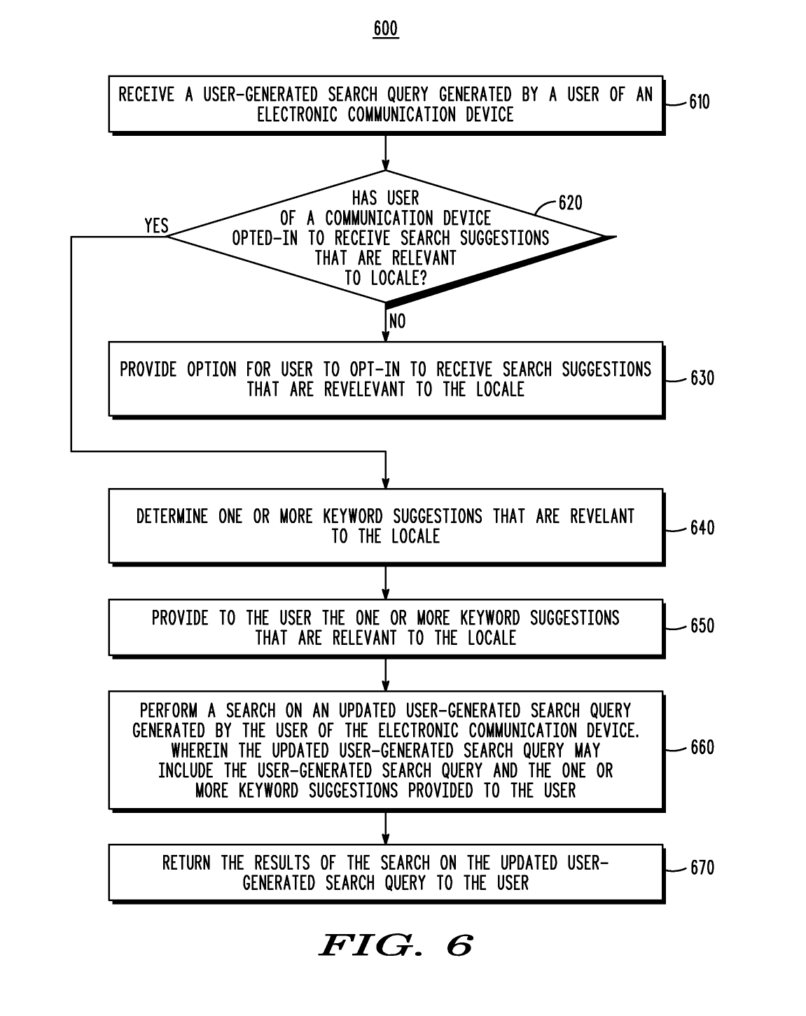

The user may be asked whether he wishes to opt-in to receive keywords associated with a given locale, if he has not already done so, after he has entered the search query. The search application which resides on the communication device, such as search application 560 of FIG. 6 may prompt the user to decide whether to opt-in, or this may occur after the search request has been transmitted by the search application to the search engine server, which may send back a communication to prompt the user to opt-in.

Search engine server 110 will then generate a search result list page and transmit the page to the user at the communication device via communication network 130. If the user has opted-in for keyword suggestions that are more relevant to the locale of interest, then the search engine server provides to the user at least one keyword suggestion that is relevant to the locale. In response to receiving the search query, search engine server 110 searches search database 116 for terms similar to the search query to determine at least one keyword suggestion that is relevant to the locale. Search engine server 116 can then provide to a search application 560 of the electronic communication device these keyword suggestions that are relevant to the locale, via communications network 130.

From the above description, then, it can be seen that a search engine server, coupled to a communications network, can facilitates locale centric search optimization. The processor and search database, coupled together and in cooperative arrangement, are configured to: in response to receiving a search query generated by a user of a electronic communication device, provide to the user at least one keyword suggestion that is relevant to the locale if the user has opted to receive search suggestions that are relevant to the locale. As discussed, the processor may further configured to determine whether the user has opted to receive search suggestions that are relevant to the locale; the server may also trigger a query to the user to be given the option to opt-in. Further, the processor and the search database of the search engine server are in cooperative arrangement and configured to perform a search on an updated search query generated by the user of the electronic communication device. The updated search query may be initial search query, in the case where the user does not use any of the suggested keywords or where none can be provided, it can be one or more keyword suggestions provided to the user that are relevant to the locale, or some combination of these. The search engine server can return the results of the search on the updated search query to the user via the electronic communication device.

Search engine server 110 may include a number of different servers, with each server having one or more processors 112, databases 116, memories 114, and respective communication interfaces 118. Load balancing between various search engine servers 110 may be employed in such configurations.

Communication device 150 is a two-way electronic communication device having at least data and possibly also voice communication capabilities, and the capability to communicate with other communication devices or computer systems, for example, via the Internet. A communication device 150 may further be a mobile or handheld electronic device and may be wireless. Depending on the functionality provided by the electronic communication device, in the various example embodiments described herein, the device may be a data communication device, a multiple-mode communication device configured for both data and voice communication, a smartphone, a mobile telephone or a personal digital assistant PDA (personal digital assistant) enabled for wireless communication, or a computer system with a wireless modem. Other examples of mobile electronic devices include mobile, or handheld, wireless communication devices such as pagers, cellular phones, cellular smart-phones, wireless organizers, wirelessly enabled notebook computers, and so forth. The mobile electronic device may also be a portable electronic device without wireless communication capabilities, such as a handheld electronic game device, digital photograph album, digital camera, or other device.

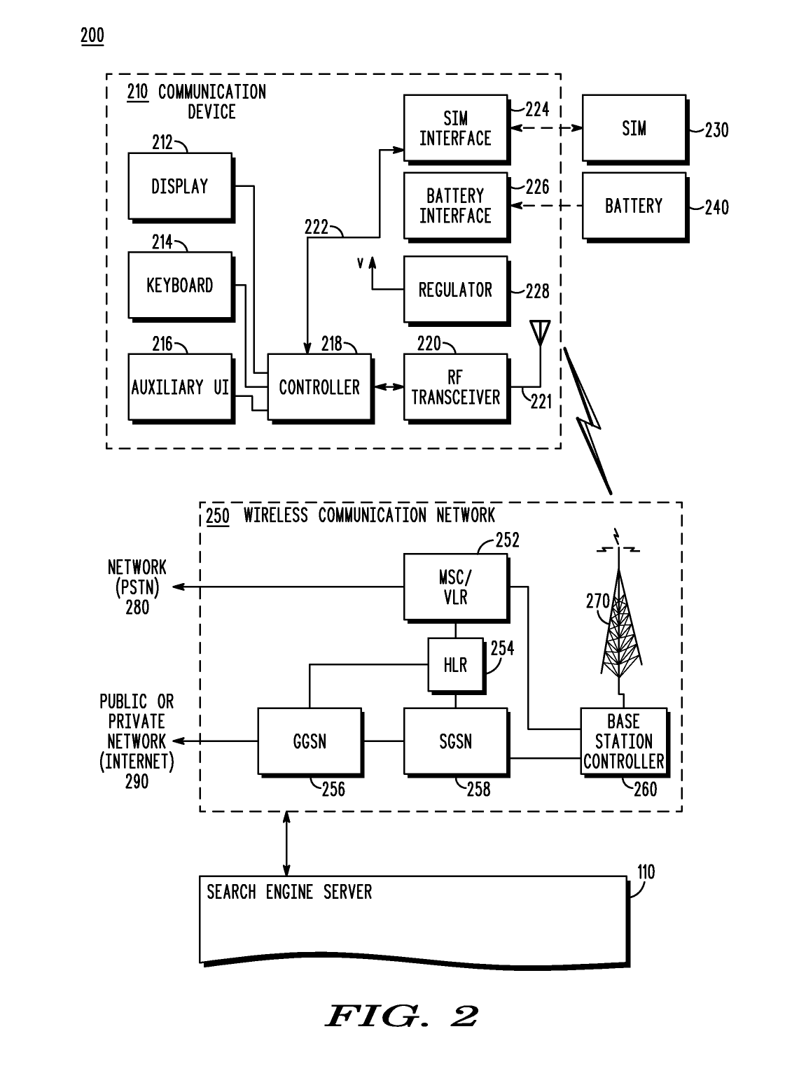

To illustrate example system architecture, FIG. 2 shows a block diagram of a wireless communication system 200 which includes an electronic communication device 210, such as a wireless or mobile communication device, which communicates through a wireless communication network 250, to a search engine server 110, as previously discussed in FIG. 1. An example wireless implementation of electronic communication device 210 and a wireless communication network 250 with which it communicates will now be discussed. Communication device 210 has a visual display 212, a keyboard 214, and perhaps one or more auxiliary user interfaces (UI) 216, each of which are coupled to a controller 218. Controller 218 is also coupled to radio frequency (RF) transceiver circuitry 220 and an antenna 221. Controller 218 may be embodied as a central processing unit (CPU) which runs operating system software in a memory component (not shown). Controller 218 will normally control overall operation of electronic communication device 210, whereas signal processing operations associated with communication functions may be performed in RF transceiver circuitry 220. Controller 218 interfaces with device display 212 to display received information, stored information, user inputs, and the like. Keyboard 214, which may be a telephone type keypad or full alphanumeric keyboard, is normally provided for entering data for storage in electronic communication device 210, information for transmission to network 250, a telephone number to place a telephone call, commands to be executed on electronic communication device 210, and possibly other or different user inputs.

Electronic communication device 210 sends communication signals to and receives communication signals from network 250 over a wireless link via antenna 221. RF transceiver circuitry 220 performs functions similar to those of a tower station 270 and a base station controller (BSC) 260, including for example modulation/demodulation and possibly encoding/decoding and encryption/decryption. It is also contemplated that RF transceiver circuitry 220 may perform certain functions in addition to those performed by BSC 260. It will be apparent to those skilled in art that RF transceiver circuitry 220 will be adapted to particular wireless network or networks in which electronic communication device 210 is intended to operate. When electronic communication device 210 is fully operational, an RF transmitter of RF transceiver circuitry 220 is typically keyed or turned on only when it is sending to network, and is otherwise turned off to conserve resources. Similarly, an RF receiver of RF transceiver circuitry 220 is typically periodically turned off to conserve power until it is needed to receive signals or information (if at all) during designated time periods.

Electronic communication device 210 includes a battery interface 226 for receiving one or more rechargeable batteries 240. Battery 240 electrical power to electrical circuitry in electronic communication device 210, and battery interface 226 provides for a mechanical and electrical connection for battery 240. Battery interface 226 is coupled to a regulator 228 which regulates power to the device. Electronic communication device 210 may be a handheld portable communication device, which includes a housing (e.g. a plastic housing) which carries and contains the electrical components of electronic communication device 210 including battery 240. Electronic communication device 210 operates using a Subscriber Identity Module (SIM) 230 which is connected to or inserted in electronic communication device 210 at a SIM interface 224. SIM 230 is one type of a conventional “smart card” used to identify an end user (or subscriber) of electronic communication device 210 and to personalize the device, among other things. Without SIM 230, the communication device terminal is not fully operational for communication through wireless network 250. By inserting SIM 230 into electronic communication device 210, an end user can have access to any and all of his/her subscribed services. SIM 230 generally includes a processor and memory for storing information. Since SIM 230 is coupled to SIM interface 224, it is coupled to controller 218 through communication lines 222. In order to identify the subscriber, SIM 230 contains some user parameters such as an International Mobile Subscriber Identity (IMSI). An advantage of using SIM 230 is that end users are not necessarily bound by any single physical mobile communication device. SIM 230 may store additional user information for the communication device 210 as well, including datebook (or calendar) information and recent call information.

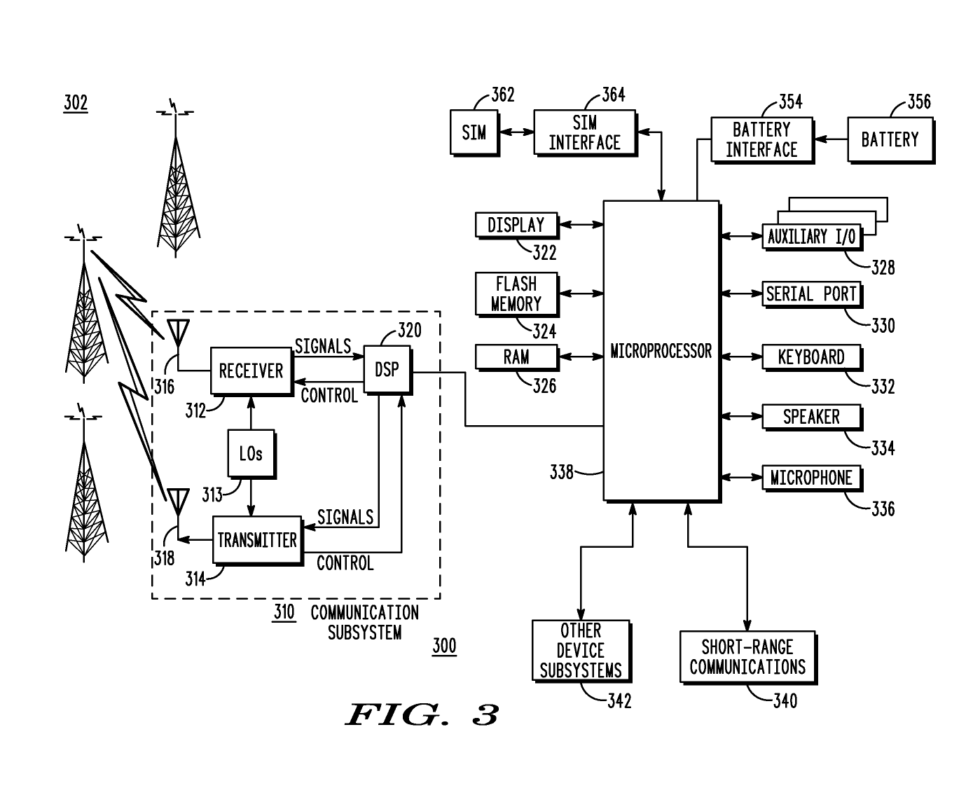

Electronic communication device 210 may consist of a single unit, such as a data communication device, a cellular telephone, a multiple-function communication device with data and voice communication capabilities, a personal digital assistant (PDA) enabled for wireless communication, or a computer incorporating an internal modem. Electronic communication device 210 may be a handheld portable communication device which includes a housing (e.g. a plastic housing) which carries and contains the electrical components of electronic communication device 210. Alternatively, electronic communication device 210 may be a multiple-module unit including a plurality of separate components, including but in no way limited to a computer or other device connected to a wireless modem. In particular, for example, in the communication device block diagram 210 of FIG. 1, RF transceiver circuitry 220 and antenna 221 may be implemented as a radio modem unit that may be inserted into a port on a laptop computer. In this case, the laptop computer would include display 212, keyboard 214, one or more auxiliary UIs 216, and controller 218 embodied as the computer's CPU. It is also contemplated that a computer or other equipment not normally capable of wireless communication may be adapted to connect to and effectively assume control of RF transceiver circuitry 220 and antenna 221 of a single-unit device such as one of those described above. Such an electronic communication device 210 may have a more particular implementation as described later in FIG. 3.

Electronic communication device 210 communicates in and through wireless communication network 250. Wireless communication network 250 may be a cellular telecommunications network. In the example embodiment of FIG. 1, wireless network 250 is configured in accordance with General Packet Radio Service (GPRS) and a Global Systems for Mobile (GSM) technologies. Today, such a mobile communication device may further operate in accordance with Enhanced Data rates for GSM Evolution (EDGE) or Enhanced GPRS (EGPRS), as described in the Background section. In such environment, wireless network 250 includes a base station controller (BSC) 260 with an associated tower station 270, a Mobile Switching Center (MSC) 252, a Home Location Register (HLR) 254, a Serving General Packet Radio Service (GPRS) Support Node (SGSN) 258, and a Gateway GPRS Support

Node (GGSN) 256. MSC 252 is coupled to BSC 260 and to a landline network, such as a Public Switched Telephone Network (PSTN) 280. SGSN 258 is coupled to BSC 260 and to GGSN 256, which is in turn coupled to a public or private data network 290 (such as the Internet). HLR 254 is coupled to MSC 252, SGSN 258, and GGSN 256.

Station 270 is a fixed transceiver station, and station 270 and BSC 260 may be referred to as transceiver equipment. The transceiver equipment provides wireless network coverage for a particular coverage area commonly referred to as a “cell”. The transceiver equipment transmits communication signals to and receives communication signals from mobile communication devices within its cell via station 270. The transceiver equipment normally performs such functions as modulation and possibly encoding and encryption of signals to be transmitted to the mobile communication device in accordance with particular, usually predetermined, communication protocols and parameters, under control of its controller. The transceiver equipment similarly demodulates and possibly decodes and decrypts, if necessary, any communication signals received from electronic communication device 210 within its cell. Communication protocols and parameters may vary between different networks. For example, one network may employ a different modulation scheme and operate at different frequencies than other networks.

The wireless link shown in communication system 200 of FIG. 2 represents one or more different channels, typically different radio frequency

(RF) channels, and associated protocols used between wireless network 250 and electronic communication device 210. An RF channel is a limited resource to be conserved, due to limits in overall bandwidth and a limited battery power of electronic communication device 210. Those skilled in art will appreciate that a wireless network in actual practice may include hundreds of cells, each served by a station 270 (i.e. or station sector), depending upon desired overall expanse of network coverage. All pertinent components may be connected by multiple switches and routers (not shown), controlled by multiple network controllers.

For all electronic communication devices 210 registered with a network operator, permanent data (such as electronic communication device 210 user's profile) as well as temporary data (such as electronic communication device's 210 current location) are stored in HLR 254. In case of a voice call to electronic communication device 210, HLR 254 is queried to determine the current location of electronic communication device 210. A

Visitor Location Register (VLR) of MSC 252 is responsible for a group of location areas and stores the data of those mobile electronic communication devices that are currently in its area of responsibility. This includes parts of the permanent communication device data that have been transmitted from HLR 254 to the VLR for faster access. However, the VLR of MSC 252 may also assign and store local data, such as temporary identifications. Optionally, the VLR of MSC 252 can be enhanced for more efficient co-ordination of GPRS and non-GPRS services and functionality (e.g. paging for circuit-switched calls which can be performed more efficiently via SGSN 258, and combined GPRS and non-GPRS location updates).

Serving GPRS Support Node (SGSN) 258 is at the same hierarchical level as MSC 252 and keeps track of the individual locations of communication devices. SGSN 258 also performs security functions and access control. Gateway GPRS Support Node (GGSN) 256 provides interworking with external packet-switched networks and is connected with SGSNs (such as SGSN 258) via an IP-based GPRS backbone network. SGSN 258 performs authentication and cipher setting procedures based on algorithms, keys, and criteria (e.g. as in existing GSM). In conventional operation, cell selection may be performed autonomously by electronic communication device 210 or by the transceiver equipment instructing electronic communication device 210 to select a particular cell. Electronic communication device 210 informs wireless network 250 when it reselects another cell or group of cells, known as a routing area.

In order to access GPRS services, electronic communication device 210 first makes its presence known to wireless network 250 by performing what is known as a GPRS “attach”. This operation establishes a logical link between electronic communication device 210 and SGSN 258 and makes electronic communication device 210 available to receive, for example, pages via SGSN, notifications of incoming GPRS data, or SMS messages over GPRS. In order to send and receive GPRS data, electronic communication device 210 assists in activating the packet data address that it wants to use. This operation makes electronic communication device 210 known to GGSN 256; interworking with external data networks can thereafter commence. User data may be transferred transparently between electronic communication device 210 and the external data networks using, for example, encapsulation and tunneling. Data packets are equipped with GPRS-specific protocol information and transferred between electronic communication device 210 and GGSN 256.

FIG. 3 is a detailed block diagram of an example mobile communication device 300 of the present disclosure. Mobile communication device 300 may be a two-way communication device having at least voice and advanced data communication capabilities, including the capability to communicate with other computer systems. Depending on the functionality provided by mobile communication device 300, it may be referred to as a data messaging device, a two-way pager, a cellular telephone with data messaging capabilities, a wireless Internet appliance, or a data communication device (with or without telephony capabilities). Mobile communication device 300 may communicate with any one of a plurality of fixed transceiver stations 302 within its geographic coverage area.

Mobile communication device 300 will normally incorporate a communication subsystem 310, which includes a receiver 312, a transmitter 314, and associated components, such as one or more (which may be embedded or internal) antenna elements 316 and 318, local oscillators (LOs) 313, and a processing module such as a digital signal processor (DSP) 320. Communication subsystem 310 is analogous to RF transceiver circuitry 220 and antenna 221 shown in FIG. 2. As will be apparent to those skilled in field of communications, particular design of communication subsystem 310 depends on the communication network in which mobile communication device 300 is intended to operate.

Mobile communication device 300 may send and receive communication signals over the network after required network registration or activation procedures have been completed. Signals received by antenna 316 through the network are input to receiver 312, which may perform such common receiver functions as signal amplification, frequency down conversion, filtering, channel selection, and like, and in example shown in FIG. 3, analog-to-digital (A/D) conversion. A/D conversion of a received signal allows more complex communication functions such as demodulation and decoding to be performed in DSP 320. In a similar manner, signals to be transmitted are processed, including modulation and encoding, for example, by DSP 320. These DSP-processed signals are input to transmitter 314 for digital-to-analog (D/A) conversion, frequency up conversion, filtering, amplification and transmission over communication network via antenna 318. DSP 320 not only processes communication signals, but also provides for receiver and transmitter control. For example, the gains applied to communication signals in receiver 312 and transmitter 314 may be adaptively controlled through automatic gain control algorithms implemented in DSP 320.

Network access is associated with a subscriber or user of mobile communication device 300, and therefore mobile communication device 300 requires a Subscriber Identity Module or “SIM” card 362 (denoted more generally as “mem” in FIG. 3) to be inserted in a SIM interface 364 in order to operate in the network. SIM 362 includes those features described in relation to FIG. 2. Mobile communication device 300 is a battery-powered device so it also includes a battery interface 354 for receiving one or more rechargeable batteries 356. Such a battery 356 provides electrical power to most if not all electrical circuitry in mobile communication device 300, and battery interface 354 provides for a mechanical and electrical connection for it. The battery interface 354 is coupled to a regulator (not shown) which provides a regulated voltage V to all of the circuitry.

Mobile communication device 300 includes a microprocessor 338 (which is one implementation of controller 218 of FIG. 2) which controls overall operation of mobile communication device 300. Communication functions, including at least data and voice communications, are performed through communication subsystem 310. The communication techniques of the present disclosure may generally be controlled by microprocessor 338 in connection with DSP 320. Microprocessor 338 also interacts with additional device subsystems such as a display 322, a flash memory 324, a random access memory (RAM) 326, auxiliary input/output (I/O) subsystems 328, a serial port 330, a keyboard 332, a speaker 334, a microphone 336, a short-range communications subsystem 340, and any other device subsystems generally designated at 342. Some of the subsystems shown in FIG. 2 perform communication-related functions, whereas other subsystems may provide “resident” or on-device functions. Notably, some subsystems, such as keyboard 332 and display 322, for example, may be used for both communication-related functions, such as entering a text message for transmission over a communication network, and device-resident functions such as a calculator or task list. Operating system software used by microprocessor 338 may be stored in a persistent store such as flash memory 324, which may alternatively be a read-only memory (ROM) or similar storage element (not shown). Those skilled in the art will appreciate that the operating system, specific device applications, or parts thereof, may be temporarily loaded into a volatile store such as RAM 326.

Microprocessor 338, in addition to its operating system functions, enables execution of software applications on mobile communication device 300. A predetermined set of applications which control basic device operations, including at least data and voice communication applications, will normally be installed on mobile communication device 300 during its manufacture. An application that may be loaded onto mobile communication device 300 may be a personal information manager (PIM) application having the ability to organize and manage data items relating to user such as, but not limited to, e-mail, calendar events, voice mails, appointments, and task items. Naturally, one or more memory stores are available on mobile communication device 300 and SIM 356 to facilitate storage of PIM data items and other information. The PIM application has the ability to send and receive data items via the wireless network. In the present disclosure, PIM data items are seamlessly integrated, synchronized, and updated via the wireless network, with the mobile device user's corresponding data items stored or associated with a host computer system thereby creating a mirrored host computer on mobile communication device 300 with respect to such items. This is especially advantageous where the host computer system is the mobile communication device user's office computer system. Additional applications may also be loaded onto mobile communication device 300 through network, an auxiliary I/O subsystem 328, serial port 330, short-range communications subsystem 340, or any other suitable subsystem 342, and installed by a user in RAM 326 or a non-volatile store (not shown) for execution by microprocessor 338. Such flexibility in application installation increases the functionality of mobile communication device 300 and may provide enhanced on-device functions, communication-related functions, or both. For example, secure communication applications may enable electronic commerce functions and other such financial transactions to be performed using mobile communication device 300.

In a data communication mode, a received signal such as a text message, an e-mail message, or web page download will be processed by communication subsystem 310 and input to microprocessor 338. Microprocessor 338 will further process the signal for output to display 322 or alternatively to auxiliary I/O device 328. A user of mobile communication device 300 may also compose data items, such as e-mail messages, for example, using-keyboard 332 in conjunction with display 322 and possibly auxiliary I/O device 328. Keyboard 332 may be a complete alphanumeric keyboard or telephone-type keypad. These composed items may be transmitted over a communication network through communication subsystem 310. For voice communications, the overall operation of mobile communication device 300 is substantially similar, except that the received signals would be output to speaker 334 and signals for transmission would be generated by microphone 336. Alternative voice or audio I/O subsystems, such as a voice message recording subsystem, may also be implemented on mobile communication device 300. Although voice or audio signal output may be accomplished primarily through speaker 334, display 322 may also be used to provide an indication of the identity of a calling party, duration of a voice call, or other voice call related information, as some examples.

Serial port 330 in FIG. 3 may be implemented in a personal digital assistant (PDA)-type communication device for which synchronization with a user's desktop computer is a desirable, albeit optional, component. Serial port 330 enables a user to set preferences through an external device or software application and extends the capabilities of mobile communication device 300 by providing for information or software downloads to mobile communication device 300 other than through a wireless communication network. The alternate download path may, for example, be used to load an encryption key onto mobile communication device 300 through a direct and thus reliable and trusted connection to thereby provide secure device communication. Short-range communications subsystem 340 of FIG. 3 is an additional optional component which provides for communication between mobile communication device 300 and different systems or devices, which need not necessarily be similar devices.

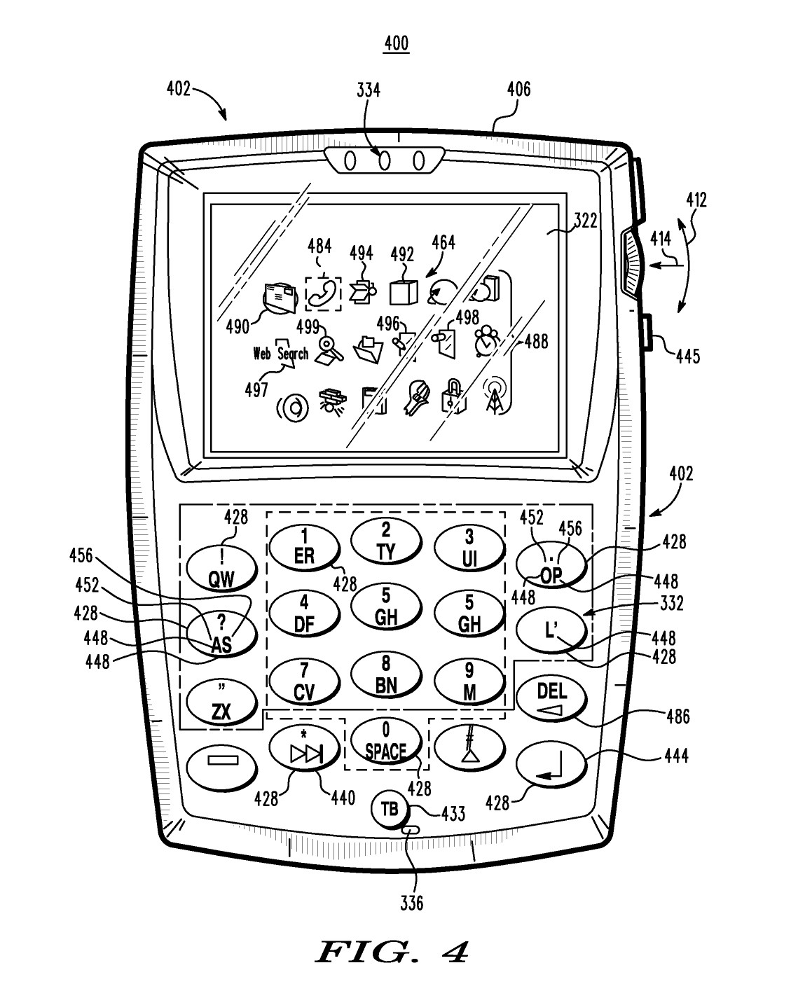

Referring now to FIG. 4, what is shown is an illustrative representation of an example user interface 402 of mobile communication device 300 of FIG. 3 which includes at least display 322, keyboard 332, speaker 334, microphone 336, and a cursor or view positioning mechanism such as a positioning wheel 410 (e.g. a scrollwheel) or a trackball 433. Although shown enlarged in FIG. 4 for clarity, this mobile communication device 300 is sized to be a handheld portable device. As an alternative to or in addition to positioning wheel 410 or trackball 433, a wide range of one or more pointing or cursor/view positioning mechanisms such as a touch pad a joystick button, a mouse, a touchscreen, a tablet, or other whether presently known or unknown, may be employed. The cursor may be or include a pointer, a movable item or other visual cue used to mark a position or point to another item on a display, in order to, for example, indicate position for data entry or for selection of the other item.

Keys 428 of keyboard 332 are disposed on a front face of a housing 406 and positioning wheel 410 is disposed at a side of housing 406. Keyboard 332 is in the example form of a reduced QWERTY keyboard including a plurality of keys 428 that serve as input members. It can be seen that the arrangement of the characters 448 on keys 428 of keyboard 424 is generally of the QWERTY arrangement, albeit with many of keys 428 including two of characters 448. In the example depiction of keyboard 424, many of keys 428 include two characters, such as including a first character 452 and a second character 456 assigned thereto. Characters may include letters, digits, symbols and the like and can additionally include ideographic characters, components thereof, and the like. One of keys 428 of keyboard 424 includes as the characters 448 thereof the letters “Q” and “W”, and an adjacent key 428 includes as the characters 448 thereof the letters “E” and “R”. Keyboard 424 may be of other configurations, such as an AZERTY keyboard, a QWERTZ keyboard, a Dvorak keyboard, or other keyboard or keypad arrangement, and either reduced or not reduced (i.e. full). In a “full” or non-reduced keyboard or keypad arrangement, each key has a single letter (not multiple letters) of the alphabet assigned to it.

Among keys 428 of keyboard 332 are a <NEXT>key 440 and an <ENTER> key 444. The <NEXT> key 440, wherein, for example, “<NEXT>” may be a symbol or may be the word “next” provided (e.g. printed) on the key, may be pressed to provide a selection input to the processor and provides substantially the same selection input as is provided by a rotational input of positioning wheel 410. Since <NEXT> key 440 is provided adjacent a number of other keys 428 of keyboard 332, the user can provide a selection input to the processor substantially without moving the user's hands away from the keyboard 332 during a text entry operation. Another key, the <ESC> key 445 is disposed on the side of housing 406 adjacent positioning wheel 438, although the same or similar key may be disposed as part of keyboard 332. Among keys 428 of the keyboard 424 additionally is a <DEL> key 486 that can be provided to delete a text entry.

Positioning wheel 410 may serve as another input member and is both rotatable, as is indicated by an arrow 412, to provide selection inputs to the processor, and also can be pressed in a direction generally toward housing 406, as is indicated by an arrow 414 to provide another selection input to the processor.

Display 322 may include a cursor 484 that depicts generally where the next input or selection from user interface 402 will be received.

Display 322 is shown in FIG. 4 as displaying a home screen that represents a number of applications 586 depicted as corresponding discrete icons 488. Icons 488 include, for example, an Electronic Mail (E-Mail) icon 490, a Calendar icon 492, an Address Book icon 494, a Tasks icon 496, a Web browser/search application icon 497, a MemoPad icon 498, and a Local Device Search icon 499, respectively.

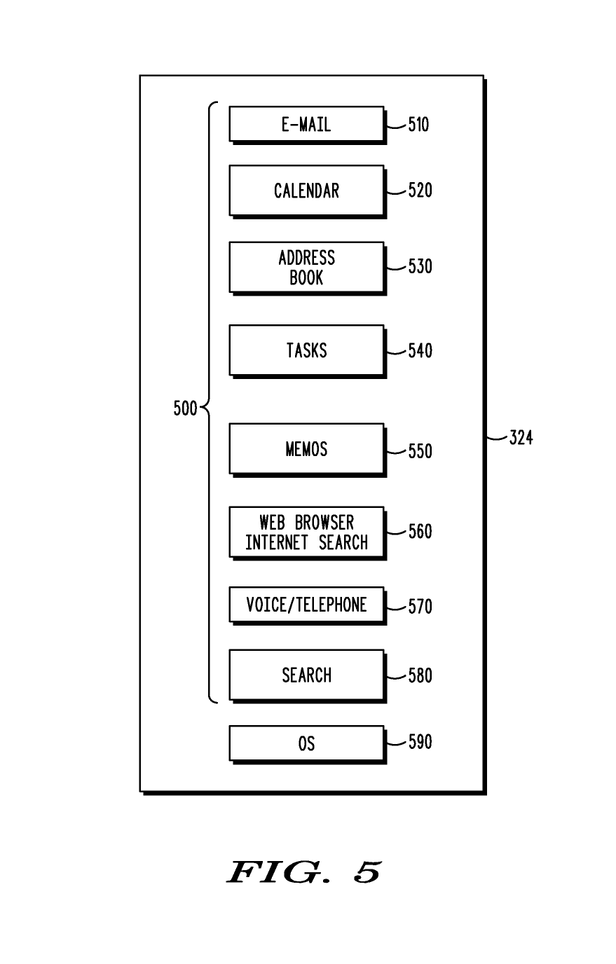

As shown further in FIG. 5, memory 224 of mobile communication device 300 includes a plurality of applications or routines 586 associated with the visually displayed icons 488 of FIG. 4 for the processing of data. Applications 586 may be in any of a variety of forms such as, without limitation, software, firmware, and the like. Applications 586 include, for example, an Electronic Mail (E-Mail) application 588 (FIG. 5) associated with E-mail icon 490 (FIG. 4), a Calendar application 590 (FIG. 5) associated with Calendar icon 492 (FIG. 4), an Address Book application 592 (FIG. 5) associated with Address Book icon 494 (FIG. 4), a Tasks application 594 (FIG. 5) associated with Tasks icon 496 (FIG. 4), a MemoPad (Memos) application 596 (FIG. 5) associated with MemoPad icon 498, a Web Browser or search application 598 (FIG. 5) associated with Web Browser/Search

Application icon 497 (FIG. 4), a Voice/Telephone application 599 (FIG. 5) associated with Voice/Telephone icon 484, and a Local Device Search application 500 (FIG. 5) associated with Local Device Search icon 499 (FIG. 4). An operating system (OS) program 516 also resides in memory 224.

In FIG. 4, the “home” screen output is shown as currently active and constitutes the main “ribbon” application for displaying the icons 488 shown. An application, such as E-mail application 588 of FIG. 5, may then be initiated (opened or viewed) from user interface 402 by providing a suitable user input to it. For example, E-mail application 588 may be initiated (opened or viewed) by rotating positioning wheel 410 to highlight E-mail icon 490 and providing a selection input by translating positioning wheel 410 in the direction indicated by arrow 438. As another example, display 322 displays icon 499 associated with Search application 500 and accepts input from positioning wheel 410 to initiate a search from that icon 499. Applications 586 may be additionally or alternatively initiated (opened or viewed) from user interface 402 by providing another suitable input to it, such as by suitably rotating or “rolling” trackball 433 and providing a selection input by, for example, pushing the trackball 433 (e.g. somewhat similar to positioning wheel 410 except into the plane of FIG. 4).

Although a specific mobile communication device 300 has just been described, any suitable mobile communication device or terminal may be part of the inventive methods and apparatus which will be described in fuller detail below. Note that many components of mobile device 202 shown and described may not be included (e.g. a full QWERTY keypad may be optional).

Reference is now made to FIG. 6, in which flowchart 600 illustrates a method of locale-centric search optimization based upon a user choosing to or opting-in to receive keyword suggestions for a particular locale, whether it be a certain region, map location, geographical area, country, etc. At Block 610, a search query generated by a user of an electronic communication device is received. At Decision Block 620, the inquiry is whether the user has opted-in to receive search suggestions that are relevant to a locale. It is noted that the user may have previously opted-in or at the time of entering the search query may be given the chance to opt-in at that time. The user may be selected by the user interfacing with a search application via a user interface of the electronic communication device 150 being used. As previously mentioned, the search application may be an application residing on the electronic communication device 150. Further, if the user opts to receive keyword suggestions for a given locale, the locale may be determined automatically by a location finding capability of the electronic communication device. But if the user has not opted-in, then at Block 630 the user is provided an opportunity to opt-in to receive search suggestions that are relevant to the locale.

If it is determined that the user has opted-in to receive search suggestions that are relevant to a locale, then at Block 640, then one or more keyword suggestions that are relevant to the locale are determined. This may be accomplished by searching a search database relevant to the locale for terms similar to the terms of the search query. The search database may be searched for terms that sound similar, have similar meaning, similar spelling, etc. At Block 650, the keyword suggestions for the given locale relevant to the search query are provided to the user. This may entail a search engine server 110 searching a search database 116 relevant to the locale for terms similar to the search query to determine the one or more keyword suggestions that are relevant to the locale. The search engine server 110 can then provide to a search application 155 of the electronic communication device 150 the one or more keyword suggestions that are relevant to the locale, via a communication network 130.

A search is now performed on an updated search query generated by the user of the electronic communication device at Block 660. The updated search query may be the initial search query (as may be the case in which the user does not select to use any of the keyword suggestions provided at Block 650), may contain one or more keyword suggestions provided to the user that are relevant to the locale, some combination, or even a new search query or string by the user. Results of the search on the updated search query are returned to the user via the electronic communication device at Block 670. As mentioned, the results may be a search result list having hypertext links by which the user can access desired search results.

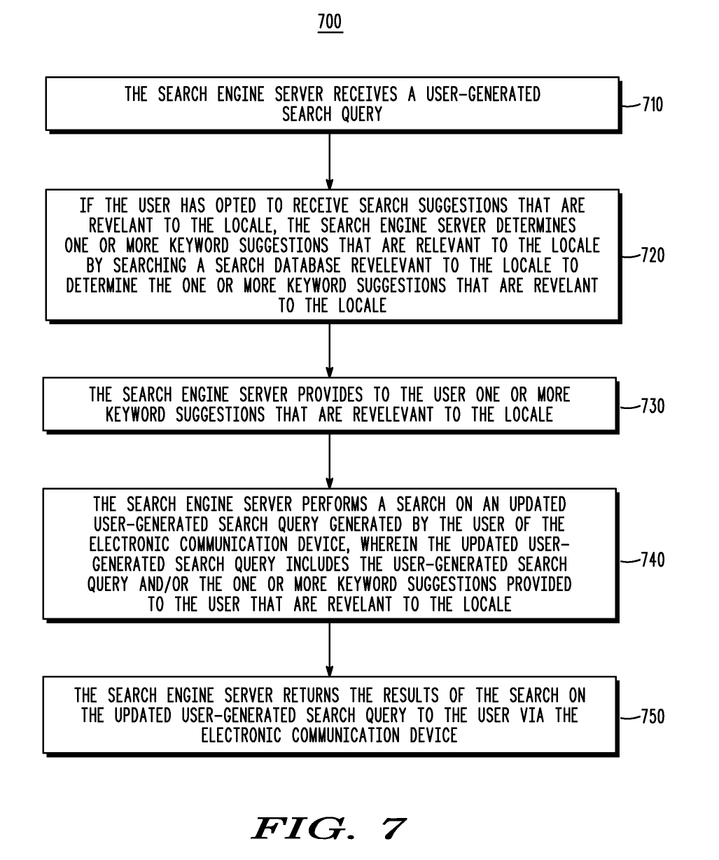

Referring now to FIG. 7, flowchart 700 illustrates a method of locale-centric search optimization from the perspective of a search engine server, in accordance with various example embodiments. At Block 710, the search engine server receives a search query. If the user has opted to receive search suggestions that are relevant to the locale, the search engine server determines one or more keyword suggestions that are relevant to the locale by searching a search database relevant to the locale to determine the one or more keyword suggestions that are relevant to the locale, at Block 720. Next, at Block 730, the search engine server provides to the user one or more keyword suggestions that are relevant to the locale. At Block 740, the search engine server performs a search on an updated search query generated by the user of the electronic communication device. As previously discussed, the updated search query may be the initial search query (as may be the case in which the user does not select to use any of the keyword suggestions provided at Block 650), may contain one or more keyword suggestions provided to the user that are relevant to the locale, some combination, or even a new search query or string by the user. The search engine server returns the results of the search on the updated search query to the user via the electronic communication device at Block 750.

While the blocks including the methods are shown as occurring in a particular order, it will be appreciated by those skilled in the art that many of the blocks are interchangeable and can occur in different orders than that shown without materially affecting the end results of the methods.

The implementations of the present disclosure described above are intended to be examples only. Those of skill in the art can effect alterations, modifications and variations to the particular example embodiments herein without departing from the intended scope of the present disclosure. Moreover, selected features from one or more of the above-described example embodiments can be combined to create alternative example embodiments not explicitly described herein.

It will be appreciated that any module or component disclosed herein that executes instructions may include or otherwise have access to non-transient and tangible computer readable media such as storage media, computer storage media, or data storage devices (removable or non-removable) such as, for example, magnetic disks, optical disks, or tape data storage. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the server, any component of or related to the network, backend, etc., or accessible or connectable thereto. Any application or module herein described may be implemented using computer readable/executable instructions that may be stored or otherwise held by such computer readable media.

The present disclosure may be embodied in other specific forms without departing from its spirit or essential characteristics. The described example embodiments are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

What is claimed is:

1. A method of locale-centric search optimization, performed by a server, comprising:
in response to receiving a search query, determining whether an option to receive search suggestions that are relevant to a locale is also received;
if it is determined that the option to receive search suggestions that are relevant to the locale is also received, providing at least one keyword suggestion that is relevant to the locale;
performing a search on an updated search query comprising one or more of the search query and the at least one keyword suggestion that is relevant to the locale; and returning the results of the search on the updated search query.

2. The method of claim 1, further comprising:
determining that the option is generated by a user opting in to receive search suggestions that are relevant to the locale.

3. The method of claim 2, wherein the user opting in occurs by the user interfacing with a search application at a user interface of the electronic communication device to select the locale.

4. The method of claim 1, further comprising in response to receiving the search query and the option to receive search suggestions that are relevant to the locale:
searching a search database relevant to the locale for terms similar to the search query to determine the at least one keyword suggestion that is relevant to the locale.

5. The method of claim 1, wherein the at least one keyword suggestion that is relevant to the locale comprises:
a search engine server searching a search database relevant to the locale for terms similar to the search query to determine the at least one keyword suggestion that is relevant to the locale; and
the search engine server providing to a search application of an electronic communication device the at least one keyword suggestion that is relevant to the locale, wherein the search engine server is coupled to the electronic communication device via a communication network.

6. The method of claim 1, wherein determining whether the option to receive search suggestions that are relevant to a locale has been received is accomplished by one or more of a search engine server and a search application running on an electronic communication device.

7. The method of claim 1, wherein performing the search on the updated search query and returning the results of the search is performed by a search engine server coupled to an electronic communication device via a communication network.

8. The method of claim 1, wherein the locale is a user-selected locale selected by a user through a user interface of an electronic communication device.

9. The method of claim 1, wherein the locale is automatically selected according to a determined location of the electronic communication device.

10. The method of claim 1, wherein the locale comprises one or more of a country, a region, a map location, and a geographical area.

11. The method of claim 1, wherein the at least one keyword suggestion correspond to words having similar meaning or spelling in the locale to terms of the search query.

12. A method of locale-centric search optimization, comprising:
in response to receiving a search query and an option to receive search suggestions that are relevant to a locale, a search engine server providing at least one keyword suggestion that is relevant to the locale;
the search engine server performing a search on an updated search query comprising one or more of the search query and the at least one keyword suggestion that is relevant to the locale; and
the search engine server returning the results of the search on the updated search query.

13. The method of claim 12, further comprising in response to receiving the search query:
the search engine server searching a search database relevant to the locale for terms similar to the search query to determine the at least one keyword suggestion that is relevant to the locale; and
the search engine server providing to a search application of an electronic communication device the at least one keyword suggestion that is relevant to the locale, wherein the search engine server is coupled to the electronic communication device via a communication network.

14. The method of claim 12, further comprising:
determining whether a user has opted to receive search suggestions that are relevant to the locale.

15. A search engine server, coupled to a communications network, that facilitates locale centric search optimization, comprising:
a processor; and
a search database coupled to and in cooperative arrangement with the processor, the search database comprising one or more locale-specific databases, and the processor and the search database configured to:
in response to receiving a search query and an option to receive search suggestions that are relevant to a locale, provide at least one keyword suggestion that is relevant to the locale.

16. The server of claim 15, wherein the processor is further configured to determine whether a user has opted to receive search suggestions that are relevant to the locale.

17. The server of claim 15, the processor and the search database in cooperative arrangement further configured to:
perform a search on an updated search query received, wherein the updated search query comprises one or more of the search query and the at least one keyword suggestion that is relevant to the locale; and
return the results of the search on the updated search query.

18. The server of claim 15, wherein the search engine server further comprises a communication interface coupled to a communication network, and the processor, the search database, and the communication interface in cooperative arrangement further configured to:
search the search database relevant to the locale for terms similar to the search query to determine the at least one keyword suggestion that is relevant to the locale; and
provide to a search application of an electronic communication device via the communication network the at least one keyword suggestion that is relevant to the locale.
